(19) United States
(12) Patent Application Publication
(10) Pub. No.: US 2024/0077165 A1
(43) Pub. Date: Mar. 7, 2024

(54) LIGHTWEIGHT STRONG PIPE FOR NEW CONSTRUCTION AND REPAIR OF PIPES

(71) Applicant: Mohammad R Ehsani, Tucson, AZ (US)

(72) Inventor: Mohammad R Ehsani, Tucson, AZ (US)

(21) Appl. No.: 17/728,896

(22) Filed: Apr. 25, 2022

(51) Int. Cl. C08J 5/18; F16L 55/17; F16L 55/163

(52) U.S. Cl. CPC C08J 5/18; F16L 55/17; F16L 55/163; C08J 2367/00

(57) ABSTRACT

Methods and systems are disclosed for manufacturing or reinforcing of any length, shape, size, and any thickness pipe with a plurality of layers comprising at least a first reinforcement sheet, a pre-designed and localized resin-fortified Core, and a second reinforcement sheet. The Core includes “A-regions” which are designed to absorb less resin, and “B-regions” which are designed to absorb more resin. For reinforcing a pipe, a first reinforcement sheet is placed over the inside and/or the outside surface of the pipe. A pre-designed and localized resin-fortified Core is placed over and adhered to the first reinforcement sheet. Subsequently a second reinforcement sheet is placed over the surface of the Core, such that the Core stays between the first and the second reinforcement sheet. Next, the resin-saturated sheets and Core are cured—depending on the type of resin—by partial or complete exposure to ambient temperature, to heat, or to light.

### CROSS-REFERENCE(S) TO RELATED APPLICATION(S)

This utility patent application claims, under 35 U.S.C. § 119, the benefit of the filing date of the U.S. provisional patent application No. 63/191,756, entitled “Lightweight Strong Pipe for New Construction and Repair of Pipes,” filed on May 21, 2021, and is also related to the U.S. Pat. No. 11,000,987, the descriptions/specifications of both of which are incorporated herein in their entirety by reference.

### TECHNICAL FIELD

This application relates generally to repair and construction of pipes. More specifically, this application relates to an easy and cost-effective method for fabrication of light-weight and high-strength pipes.

### BRIEF DESCRIPTION OF THE DRAWINGS

The drawings, when considered in connection with the following description, are presented for the purpose of facilitating an understanding of the subject matter sought to be protected.

FIGS. 1A, 1B, and 1C show examples of three rectangular patches of core materials that include A- and B-regions;

FIGS. 2A and 2B show examples of two rectangular patches of core materials with continuous and discontinuous B-regions;

FIG. 3 shows an example of a rectangular patch of core material with small individual B-regions;

FIG. 4 depicts a simple example of an adjustable size and shape mandrel; and

FIG. 5 schematically illustrates the process of “slip-lining” for repair and/or reinforcement of a damaged and/or weak pipe.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed.

Pipelines are used worldwide for conveyance of liquids and gases. Common materials for pipe construction include concrete, steel, iron, HDP, Fiberglass and other plastics, etc. The problem with all pipes is that their walls are solid and primarily made from the same material as the rest of the pipe. Examples include steel, concrete and PVC pipes. Such pipes tend to become very heavy. In some cases, to gain strength and rigidity at a lower (reduced) weight, corrugated pipes can be used. But corrugated pipes can only be manufactured with certain materials; thin sheet metal and some plastics like PVC and HDPE are the most common materials used to build corrugated pipes. Other materials like concrete, steel and fiberglass do not lend themselves to the corrugation process. Other manufacturers like Hobas® pipe use a mix of sand and resin at the core (near the middle of the pipe wall thickness) to save on cost since that region, similar to the web of an I-beam, contributes little to the strength of the pipe. Even so, those pipes are very heavy and while filling the resin with sand can reduce the cost of the pipe, it does not reduce the weight of the pipe.

Ehsani has proposed a method for repairing existing pipes where a 3D fabric is used as the “core” or central part of the wall of the pipe (U.S. Pat. No. 11,000,987). That core is covered with various layers of Fiber Reinforced Polymer (FRP) fabric that are saturated with a resin. The advantage of that type of repair or pipe is its light weight. However, when those pipes are loaded by external loads such as those caused from soil or traffic above, the short glass fibers “columns” in the 3D fabric may buckle and collapse. One way to overcome this problem as suggested by Ehsani is to inject the 3D fabric with a material such as concrete, foam, or resin, etc. to provide continuous support for those short “pillars” or “columns” in the 3D fabric and prevent their buckling. But that may add some difficulty during the construction process.

Therefore, there still remains a need for development of a non-corroding light weight, inexpensive, and strong pipe. The method and technique disclosed below address these problems by offering a very efficient and cost-effective solution. This new pipe is referred to as Lightweight Strong Pipe (LSP).

Construction of LSP is relatively simple as discussed in detail below. One of the advantages of this technology is that it allows manufacturing a pipe of any shape and/or size, anywhere in the world, with little manufacturing equipment or heavy lifting equipment. Various layers of resin-saturated or resin-fortified Fiber Reinforced Polymer (FRP) fabrics of glass, carbon and the like are wrapped around a mandrel with optional Core layers positioned between those FRP layers for added stiffness and strength. The entire assembly is allowed to cure fully or partially, resulting in a pipe of desired strength and stiffness (rigidity). The finished pipe is removed from the collapsible mandrel and the process is repeated. Because the “Core” is a significant feature of the LSP, it will be discussed in detail below.

In some occasions throughout this disclosure the term “resin-fortified” is used to emphasize that the material or the region is not necessarily 100% saturated, even though it might be.

In this disclosure, a number of laminate-bulker or core materials are discussed. These materials perform a fundamental function in the behavior of the overall composite structure, including increased strength and stiffness at low cost and reduced weight. All of these will hereafter be referred to as “Core”. The Core has a distinct design and characteristic that is different from other FRP fabric such as glass, or carbon fabric, chopped mat, 3D fabric, foam, etc. and offers significant advantages and benefits compared to those fabrics.

The Core materials are laminate-bulkers that can be used in both open mold processes like hand lay up (HLU) and spray up (SU). For HLU and SU it is important that the product wets out quickly but also remains intact long enough to be processed. The product also needs to be flexible to conform to the shape of the mold. Core products are made by incorporating microspheres in a polyester based fleece or other fibers. Because of these microspheres, Core products create a low weight volume and increased stiffness without the extensive use of costly materials.

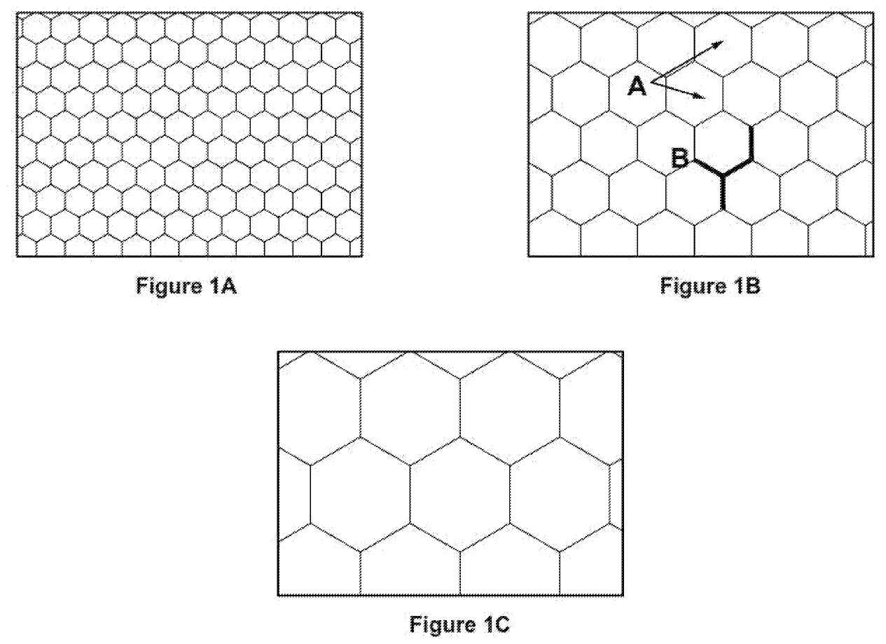

The Core can be designed from a variety of materials such as polyester fibers, glass fibers, felt, various nonmetallic mats and chopped fibers, foam, fleece, etc. A key feature of the Core that will be designed by the engineer(s) for each specific application is the ability of the Core to be infused with resin through pre-determined (pre-designed) channels or pathways. To better understand the present disclosure, the Core is divided into two distinct parts or regions A and B, as shown in FIGS. 1A, 1B, and 1C. The “A-parts or regions” define the regions where fibers exist (also called “Core Shores”); these typically receive significantly less quantities of resin during the fortification, infusion, or saturation process. The “B-parts or regions” represent cavities (canals, pathways, channels, etc.) within the Core where the resin is allowed to flow through more easily and fill the B-parts or regions fully or partially. In some embodiments the B-regions also contain some fibers but a different kind of fiber or less fiber than the fibers in A-regions so that the B-regions can absorb more resin than the A-regions. In other embodiments the B-regions have no fibers at all so that the B-regions can again absorb more resin than the A-regions.

In various embodiments one or both sides of the Core may have a thin cover or thin coating or film of different materials through some of which resin can pass. This thin cover is traditionally called a “Vail”. If one side of the Core has a vail, it is much easier to wrap it around a curved surface, such as a mandrel, by placing the vailed surface on the mandrel and letting the Core open up as controlled by the radius of the mandrel. In general, the Core, whether vailed or not, is manufactured such that if liquid is poured over its surface the B-regions absorb more liquid (per volume) than the A-regions and the B-regions are saturated before the A-regions.

Some Core materials have been recently manufactured by companies such as Lantor® under the brand names Soric® or CoreMat®. These companies make different designs as described below. CoreMat®, for example, is made by incorporating microspheres in a polyester based fleece to serve as a core and flow media for resin. The Core product remains flexible to conform to the shape of the mold. However, the design is not limited to those patterns and engineers can design Core materials that meet the performance requirements of each specific job and LSP.

In some applications, the B-regions of the Core may consist of cavity canals that provide a continuous (i.e. connected) pathway for the resin to travel throughout and impregnate the Core. As shown in FIGS. 1A, 1B, and 1C, the B-regions or pathways that are connected together to form a honeycomb (hexagonal) pattern. In this example, the B-regions encompass or surround the A-regions such that each A-region is fully or partially separated from the neighboring A-region by a wall of resin. A part of the design based on load and strength requirements is the size and density of the cells (or the B-regions). In FIG. 1A, for example, the Core has smaller cells (more B-regions) while the Core in FIG. 1B has larger cells (less B-regions) as a percentage of the overall surface area of the Core. On the other hand, the Core in FIG. 1C has very large cells (least amount of B-region) and is designed for applications where minimal resin is required. This flexibility in design, which allows the engineers to decide what percentage of the total area of the Core will be resin (B-region) and what percentage will be fibers (A-region), is an important feature of these Cores compared to commonly used FRP fabrics that get fully and uniformly filled/saturated with resin. The smaller volume of resin used in this design with large cells, not only changes the strength of the Core, but also reduces the cost (since resins are much more expensive than fibers) and the weight of the finished product (after infusion with resin).

The thickness of these Cores, which itself may be a design parameter, can range, for example, from about 1 mm to 25 mm and larger or smaller. This thickness is also a major contributing factor to the shear, tension, compression and flexural strength of the Core as well as the final product (i.e. the LSP) that is made with the Core.

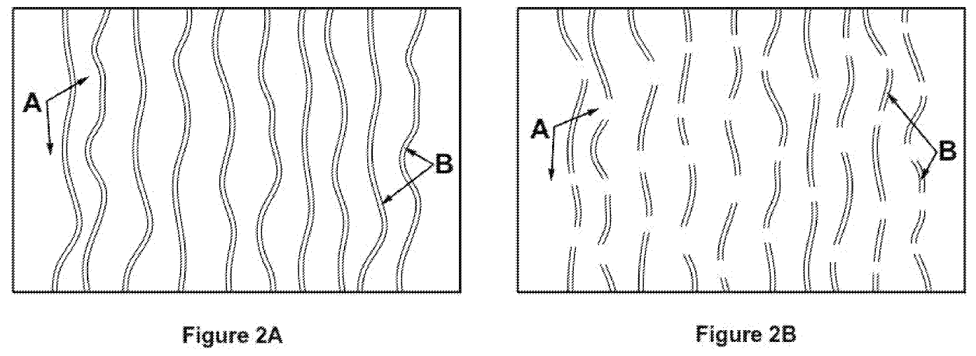

Cores are typically fabricated as flat sheets with primary dimensions in the X-Y plane and a small thickness (about 1 mm to 25 mm) in the Z-direction. In some embodiments, it may be preferable to have unbalanced or irregular pathways. In such cases, the B-region may be made of rectangular cell patterns (instead of hexagonal) whose sides can be equal (like a square) or unequal like a rectangle. In other embodiments, the B-regions may be in the form of parallel lines that run in the X or Y direction only and not intersecting each other. As shown in FIGS. 2A and 2B, these “walls” need not be straight in the X or Y direction and can be curved (similar to corrugated patterns), circular, helical, or random shapes, etc. When filled with resin, these act like “walls” of resin that run in the X or Y direction only. The thickness of these walls and their spacing (e.g., from the adjacent walls), which may also be a design factor, also contribute to the shear, tensile, compression, and bending strength of the Core and the finished product, i.e. LSP.

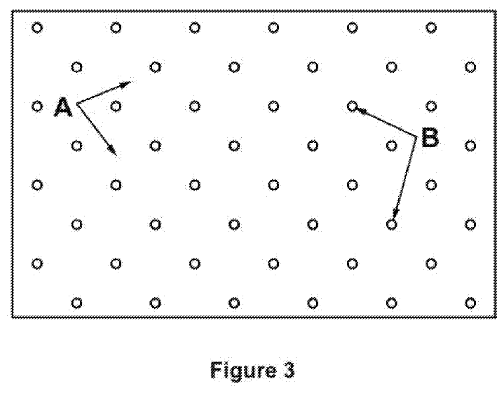

In some embodiments, the Core may have pathways (B-regions) that are connected together as shown in FIGS. 1A, 1B and 1C. In other embodiments, these B-regions may be disconnected (FIGS. 2A, 2B and 3) to provide specific structural performance for some portions of the LSP (i.e., in the vicinity of the connected pathways) that are different from structural performance of other portions of the LSP which are in the vicinity of disjointed or individual pathway walls.

In some embodiments, it is preferred to have B-regions that are individual cavities in the form of a small diameter cylindrical cell that may be filled with resin (FIG. 3). Looking at the plan view of such Core material these may look like unconnected dots and once filled with resin they perform as a series of columns of resin whose height is approximately equal to the height/thickness of the Core, i.e. 1 mm to 25 mm. In the example shown in FIG. 3, the A-region of the Core is continuous (all connected together) and the B-regions are disconnected single (or individual) cells rather than continuous connected or disconnected walls.

The Core can also be used in the design as a watertight membrane to prevent leaking of the pipe. In such cases, it may be preferable to fully saturate the Core. In various embodiments, a chopped mat can be added (e.g. stitched or otherwise bonded) to the Core to enhance watertightness of the pipe.

When ordinary FRP fabrics are saturated with resin, the resin flows freely throughout the fabric and fills all voids. This results in a uniformly saturated product and prevents the engineer to design special or desired localized strength and stiffness features into the finished product. A primary feature and advantage of the Core materials is that they have predetermined solid (A-region) locations and hollow or cavities (B-regions) where the resin can be injected into. The location and amount of the A- and B-regions will be designed by the engineers to achieve the optimum strength and stiffness. This determines the quantity of the resin that is needed to fully saturate or to partially fortify the Core. The infusion of the Core with a predetermined and/or calculated amount of resin and a predetermined and/or calculated distribution of resin results in a lighter, stronger and more economical structure compared to other ordinary FRP fabrics saturated with resin.

In addition, the precise knowledge of the size and location of B-regions allows the design engineers to produce products that have the right shear, tension, compression and flexure strength in any X, Y, and Z direction and at any location in the finished structure, such as LSP. For example, in various embodiments, one can determine the amount of resin in A-region and vary it from 0% (a dry or unsaturated region) to 100% (a fully resin-saturated region) as part of the design. This type of variation in resin content is impossible with the old technique where a layer of FRP fabric is uniformly saturated with resin. Using the old technology, for example, if one decides to partially saturate the fabric, the entire fabric will be randomly and partially saturated. The engineers or manufacturers have no control as to which parts of the fabric will get fortified and to what percentage of fortification.

In various embodiments the thickness of the cells or walls forming the B-regions in FIGS. 1A, 1B, 1C, 2A and 2B can be from 0.1 mm to 3 mm or larger or smaller. Similarly, the diameter of the B-cells shown in FIG. 3 are typically from 0.1 mm to 3 mm or larger or smaller.

While the location and size of the A- and B-regions affect the volume of resin being used, the cost, and the weight of the finished product, etc., their main contribution is in the strength and stiffness of the finished product. Designing a Core with pre-determined size, distribution and shape of A- and B-regions allow the engineers to design a finished product with desired strength and stiffness in any direction and at any location in the structure. This is impossible to achieve with FRP fabrics that are uniformly saturated.

In some embodiments, it may be preferable to infuse the Core with a resin as a first step and allow the Core to partially or fully cure. When such treated Core is pressed between one's two fingers, for example, the Core has become more rigid (i.e. not as spongy as the original Core) and it will not compress into a thinner laminate. In other words, the partial curing of the resin in the first step ensures that the thickness of the Core remains unchanged in subsequent operations, such as filling it with resin or using vacuum to inject resin through the Core. It is known that in vacuum injection process, Core materials may collapse or lose their thickness because of the vacuum pressure. The above procedure described in this paragraph ensures that the overall thickness of the Core will remain fixed because of the fully or partially cured resin in B-regions. In various embodiments, the resin can be infused by hand, with rollers, sprays, or by vacuum injection.

In a variation of the above, for example a 10 mm thick Core can be infused with resin during a first preparation phase. Once the resin is infused into the B-regions, the entire Core may be compressed to a thinner thickness, such as 8 mm, and allow the resin to cure in that stage. This results in a modified Core at the end of this operation that has a thickness of 8 mm instead of 10 mm. The cured resin then “forces” the Core to remain in that compressed 8 mm thickness during subsequent stages of manufacturing. Such modification of the Core as a “pre-fabrication” stage allows the engineers to further modify the strength of the Core and the structural element such as the LSP that is being manufactured with this 8 mm Core.

In various embodiments, different resin viscosities may be used to infuse the Core. These resins can flow through some B-regions for example but not through other B-regions depending on the size and design of the particular B-regions. Such infusion can result in endless combinations of shear, flexural, axial tension and compression and cross compression and tension strength in the Core and the finished structure (i.e. LSP). This, for example, can allow the LSP to be stronger in regions where loads are larger, such as an area where the LSP is buried under heavy traffic or railroad tracks! Likewise, the above-mentioned features allow the engineer to customize the strength of the LSP at any location along the length of the pipe. For example, the spring lines may be made stronger than the crown or invert of the pipe, or vice versa.

The Lightweight Strong Pipe (LSP) may be built, for example, in two different ways: a) as a standalone pipe and b) as a method to strengthen and/or repair an existing pipe. The standalone pipe itself may be used in two distinct applications: 1) for a free-standing pipe to build a new pipeline, and 2) for slip-lining an existing deteriorated pipe. All of these are discussed in more detail below.

a) Stand-Alone Pipe:

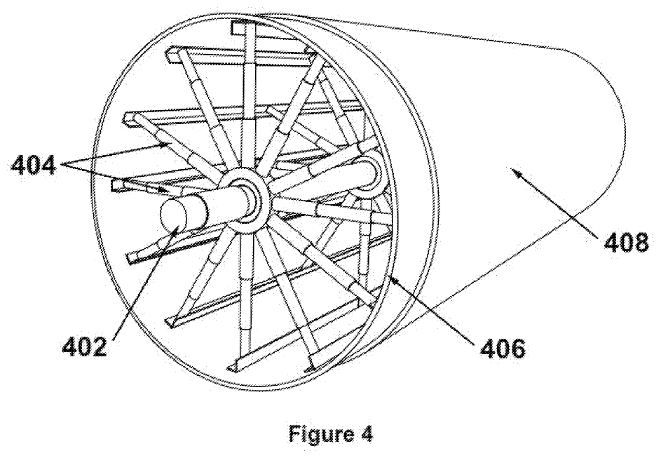

One possible method of construction uses, for example, a collapsible mandrel as shown. One of the advantages of this technology is that the construction of LSP is very simple and allows one to build a pipe of any shape or size anywhere in the world with little manufacturing and with no heavy lifting equipment. In some embodiments, as shown in FIG. 4, a mandrel is provided, using telescopic arms 404 that are perpendicularly and radially attached to a central shaft 402. These arms 404 can be extended or retracted to create a mandrel of any shape or size. If the arms 404 are all extended to the same length, the resulting surface 406 will produce a cylindrical pipe; but by extending the arms 404 to different lengths, the final shape can be any non-circular shape, such as ellipse, oval, etc. (see FIG. 4). The outer skin 406 of the mandrel can be covered with a sheet metal or other non-stick surfaces. Fabrics 408 of glass or carbon, for example 2- or 4-ft wide bands, are fortified or saturated with resins (e.g. epoxy, polyester, vinylester, etc.) and wrapped snuggly around the mandrel. The mandrel can also include a rotating mechanism about its center shaft 402. These initial wraps 408 may be one or multiple layers of FRP. Additional bands of FRP fabric will be wrapped around the mandrel adjacent to the previous band; these could be butt-jointed or overlap the previous band. This process may be continued until the full length of the mandrel is substantially covered with FRP fabric 408.

The next step is application of the Core, which for example is also supplied in 2-ft or 4-ft wide sheets. The properly designed and/or calculated Core is selected and fortified with the appropriate resin; it is then wrapped around the mandrel on top of the previously wrapped FRP fabric 408. If necessary, a layer of resin is applied between the Core and the FRP sheet 408 that was applied earlier. The resin in all the steps of the process may be applied to the fabric and Core before, during, or after the wrapping of the fabric or Core. The Core is preferably cut so that its length is exactly equal to the perimeter of the mandrel, including accounting for the increased diameter due to the previously applied FRP fabric layers. This ensures a perfect butt joint in the hoop direction. The next Core piece is applied adjacent to the first one, with butting joints. Additional resin may be applied to the top of the Core and over the joints (as filler material). In some embodiments one may wait for some time to allow the resin to fully penetrate the Core or to allow the resin inside (within) the Core to cure fully or partially. Subsequently, additional layers of resin-saturated/fortified glass or carbon fabric are wrapped on top of the Core. These steps are repeated as many times as needed, applying FRP fabric and/or Core and resin until the desired/designed thickness for the pipe wall is achieved.

In some embodiments, there will be more than one layer of Core used to build the LSP. Each layer of Core may have a different design or pattern for the A- and B-regions as determined by the design engineers to optimize the performance of the overall structure or LSP. For example, one layer of Core may have a larger percentage of B-region and could be fully saturated to serve as a watertight membrane. Another layer of Core may have a plurality of single (unconnected) B-cells that when filled with resin will provide compression and shear strength to the Core and will enhance the ring stiffness and pressure rating of the LSP.

In various projects, a non-circular pipe may be preferred and such pipes can be constructed according to this disclosure. In such cases, for example, the same mandrel discussed in FIG. 4 may be used to build a non-circular pipe but the telescopic arms 404 of the mandrel must be extended outward to different lengths from the central core 402 of the mandrel. Once a sheet metal 406 is placed on and wrapped around the extended arms, a non-circular geometrical shape is created as the mold for building this LSP.

Another advantage of the LSP is the relatively easy construction technique that does not require major heavy manufacturing facilities and which allows one to build a pipe in virtually any size by increments as little as a fraction of an inch. This is achieved by extending the arms 404 of the mandrel to the desired lengths and securing them at that length, which is an important feature of LSP since conventional pipes are typically offered in 6-inch diameter increments, e.g. diameters of 48, 54, 60, 66, 72 inch and so on. LSP can be made to a diameter of 51.5 inch, for example. In applications where LSP is used to slip-line an existing pipe, this feature maximizes the volume of flow through the pipe after the repairs and adds great value for the repair technique. One can, for example, build a pipe that leaves only a small annular space (e.g. ½ inch) between the host pipe and LSP, to be filled with a filler material, if desired, and leaves a greater percentage of the original pipe diameter available for flow after the repair.

The wrapped materials are allowed to cure around the mandrel—preferably undisturbed until the resin cures. Curing of resin can be done in ambient temperature or accelerated by heating the mandrel. Likewise, if a UV-cured resin is used, UV light can be provided to cause curing of the resin. The cured pipe is removed from the collapsible mandrel and is stored for field installation.

In various embodiments the first layer of fabric being wrapped around the mandrel can include especial chemicals and coating. These will form the interior surface of the finished pipe and can serve as “top coat” for additional benefits such as abrasion resistance, chemical resistance against H₂S gas and other chemicals, etc. when the pipe is placed in service.

One of the uses of the LSP is for construction of new pipelines. The pipe segments are transported to the field and their ends are connected together. The ends can include male and female connections and optional gaskets at opposite ends such as bell and spigot joints. Once the pipe segments are connected and buried in a trench, they can be covered with backfill soil.

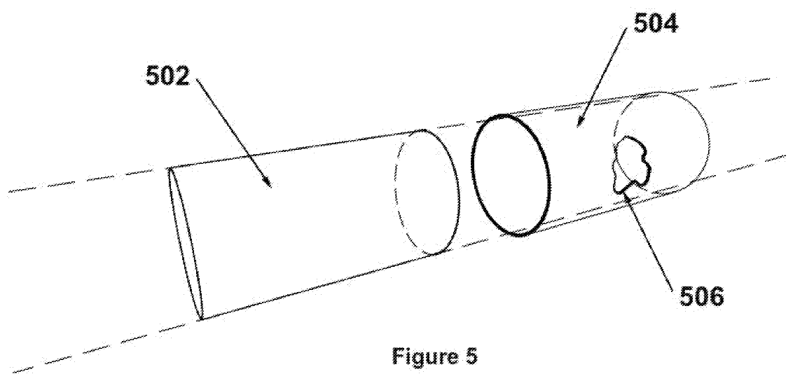

Another use of LSP is for repair of existing pipes and tunnels. The process known in the art as “slip-lining” (FIG. 5). LSP segments 502 with an outside diameter slightly smaller than the inside diameter of the pipe 504 or of the tunnel 504, which are being repaired, are manufactured. An access pit is created and a piece of the original pipe or tunnel 504 is removed. Segments of LSP 502 are lowered into the host pipe or tunnel, and one by one they are connected together and pushed into the host pipe or tunnel 504. In some embodiments, once the tunnel or pipe 504 is lined, the annular space between the host pipe or tunnel 504 and the LSP 502 is filled with grout or other fillers. The newly installed LSP 502 will resist all or most of the loads and pressures of the tunnel from this point on, with little or no reliance on the strength provided by the original host pipe or tunnel 504. In the schematic example of FIG. 5, the original pipe 504 has a hole 506 which wastes the content of pipe 504 and may cause hazardous accidents.

In a recent project in Detroit, Michigan, a 17.5-ft diameter tunnel was slip-lined with LSP segments of 16-ft outside diameter which was fabricated near the job site on a collapsible mandrel. An arc piece of the pipe was built with two layers of Core and ten layers of GFRP glass fabric and CFRP carbon fabric. Each Core layer had a different design and served a different function for the strength and watertightness of the pipe. The tests showed that even though the LSP for this project weighed less than 10% of conventional pipes, it was noticeably strong and stiff. At the present there are no US factories that can manufacture a 16-ft diameter pipe for such a project. Even the transportation of such a pipe from any factory to the jobsite in Detroit through the interstate highways and under overpasses are impossible. The disclosed LSP allows building of such large diameter pipes only a short distance from the job sites to be able to deliver them to the job sites. The 16-ft diameter pipe weighs only 450 pounds per foot, making handling and installation of longer segments easy.

b) Repair of Existing Pipes:

The techniques presented here apply to repair and strengthening of a pipe from either outside or inside of the pipe. For pipes with small diameters or when flow cannot be disrupted, repairs from outside are preferred. In both cases, the surface of the pipe may be cleaned to ensure proper bonding between the resin and fabric and the pipe surface. In various embodiments any damage to the pipe, e.g. holes and cracks may also be patched before the strengthening begins.

In various embodiments one or more layers of resin-saturated/fortified carbon or glass FRP fabric is applied to the pipe surface. A layer of properly designed and resin-fortified Core, to meet the specific requirements of this job for strength, stiffness, water tightness, etc., is applied to the previous FRP layers, preferably letting these layers to bond together. Saturation or fortification of fabric and infusion of Core can be done before, during or after they are applied and can be achieved by rollers, sprayers, vacuum injection, and the like. Additional layer(s) of resin saturated FRP fabric is applied on top of the Core, and enough overlap is provided along the length of the pipe and in the hoop direction to develop the full capacity of the fabric and Core and to achieve the desired strength for the repair system. The edges may be trimmed by cutting and removing any loose fibers and be made smooth and finished with a layer of thickened epoxy, etc. A final topcoat may be applied to the finished surface. As an example, for externally wrapped systems, the topcoat can provide UV resistance and for internally wrapped repairs, the topcoat can provide abrasion resistance, or protection against harsh chemicals, H₂S gases, etc.

In various embodiments, a layer of thickened epoxy (i.e. Tack Coat) may be applied between the layers of fabric or the fabric and the pipe surface to ensure that the saturated or fortified materials do not droop and remain in place while the resin is curing.

In various embodiments, having a predetermined “placement” for resin rather than a randomly filling and saturating the resin is a significant improvement offered by the current disclosure. In some embodiments, after the fabric and Core are applied the entire installation can be encapsulated in a large plastic bag, the edges will be sealed airtight and resin will be applied from inlet ports and sucked out from other ports in a process known as vacuum injection.

In some embodiments the resin used is an especial epoxy resin formula, invented in Institute of Applied Synthetic Chemistry, TU Wien. When any part of this resin, which is initially transparent and either in liquid or paste form, is irradiated with the appropriate light, the entire resin begins to solidify. The process of curing this resin may even be carried out underwater in projects such as filling underwater cracks in bridge pillars or dams, or repairing pipes during ongoing operation. The mentioned resin may be produced by adding especial additives to ordinary epoxy resin in order to adjust its properties and enable targeted curing at the touch of a button. The curing and solidification of this resin is a chemical reaction triggered by light. This can be a bright flash of visible light or other appropriate lights such as UV light. At the point where the light strikes the resin, a reaction starts that releases heat, and this heat spreads and initiates a chemical cascade elsewhere until all the entire resin is cured. The advantage of this method is that it is not necessary to illuminate the entire resin as with other light-curing materials.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

1. A method of reinforcing or repairing a pipe, the method comprising:
placing at least a first sheet of resin-fortified material over an inside and/or an outside surface of the pipe;
placing at least a resin-fortified core material over the first sheet of resin-fortified material, wherein the core material includes core canals and core shores and wherein the core canals, per volume, absorb more resin than the core shores and wherein different localized parts of the core canals and/or core shores are resin-fortified differently according to engineering design and calculations;
placing at least a second sheet of resin-fortified material over a surface of the resin-fortified core material, wherein the resin-fortified core material stays between the first and the second sheets of resin-fortified material; and
curing resins of the resin-fortified materials.

2. The method of claim 1, wherein the resin-fortified core is resin-fortified before, during, or after being placed over the first sheet of resin-fortified material.

3. The method of claim 1, wherein curing is achieved by exposure, entirely or partially, to ambient temperature, to heat, or to light.

4. The method of claim 1, wherein layout of the resin-fortified core is designed to include canals of proper size and distribution and also fortification of the resin- fortified core is designed to result in a desired strength for the pipe.

5. The method of claim 1, wherein the resin-fortified core is Soric® or Coremat®, manufactured by Lantor® company.

6. The method of claim 1, wherein the method steps are repeated to accomplish desired reinforcement.

7. The method of claim 1, wherein adhesives are added between layers of the resin-fortified core and the sheets of the resin-fortified materials.

8. A method of manufacturing a pipe, the method comprising:
providing a mandrel of desired shape and size;
placing at least a first sheet of resin-fortified material over an outside surface of the mandrel;
placing at least a resin-fortified core layer over the first sheet of resin-fortified material, wherein the core layer includes core canals, which are connected or disconnected, and core shores and wherein the core canals, per volume, absorb more resin than the core shores and wherein in different localized parts of the core layer, the core canals and/or core shores, a different amount of resin is injected or infused, according to engineering design and calculations, to obtain different desired localized mechanical properties and different desired localized strengths;
placing at least a second sheet of resin-fortified material over a surface of the core layer, wherein the core layer stays between the first and the second sheets of resin-fortified material; and
curing resins.

9. The method of claim 8, wherein the mandrel is collapsible and is of any shape and size.

10. The method of claim 8, wherein the resin-fortified core layer is resin-fortified before, during, or after being placed over the first sheet of resin-fortified material.

11. The method of claim 8, wherein curing is achieved by exposure to ambient temperature, to heat, or to visible or UV light.

12. The method of claim 8, wherein layout of the resin-fortified core layer is designed to include canals of proper size and distribution and also fortification of the resin-fortified core layer is designed to result in a desired strength for each locality of the pipe.

13. The method of claim 8, wherein the resin-fortified core layer is Soric® or Coremat®, manufactured by Lantor® company and wherein Soric® includes a structure in which microspheres are incorporated in a polyester based fleece with a pressure-resistant binder in a form of islands and channels and includes hexagon foam cells that do not absorb any resin while channels between the cells allow the resin to flow, and wherein Coremat® includes a structure in which microspheres are indorporated in a polyester based fleece in a form of islands and channels and is made with a styrene dissolvable binder.

14. The method of claim 8, wherein adhesives are added between layers of the resin-fortified core layer and the sheets of the resin-fortified materials.

15. A method of manufacturing a strong-panel for fabricating or reinforcing or repairing a structure, the method comprising:
placing at least a first sheet of resin-fortified material over an outside and/or inside surface of the structure or a surface corresponding to the structure surface;
placing at least a resin-fortified core layer over the first sheet of resin-fortified material, wherein the core layer includes core channels and core isles and wherein upon introduction of resin, the core channels, per volume, absorb more resin than the core isles and wherein different regions of the core channels and/or core isles are resin fortified differently according to engineering design and calculations;
placing at least a second sheet of resin-fortified material over a surface of the core layer, wherein the resin-fortified core layer stays between the first and the second sheets of resin-fortified material; and
curing the resin-fortified materials either on the structure surface or on the surface corresponding to the structure surface.

16. The method of claim 15, wherein adhesives are added between layers of the resin-fortified core layer and the sheets of resin-fortified materials.

17. The method of claim 15, wherein the resin-fortified core layer is resin-fortified before, during, or after being placed over the first sheet of resin-fortified material.

18. The method of claim 15, wherein curing is achieved by exposure to ambient temperature, to heat, or to visible or UV or other lights.

19. The method of claim 15, wherein layout of the resin-fortified core layer is designed to include channels of proper size and distribution and also fortification of the resin-fortified core layer is designed to result in a desired localized strength of the pipe.

20. The method of claim 7, wherein the three-dimensional (3D) resin-fortified core is Soric® or Coremat®, manufactured by Lantor® company.
